(19) United States
(12) Patent Application Publication
(10) Pub. No.: US 2008/0222176 A1
(43) Pub. Date: Sep. 11, 2008

(54) STREAMING XPATH ALGORITHM FOR XPATH EXPRESSIONS WITH PREDICATES

(75) Inventors: Mengchu CAI, San Jose, CA (US); Jason Alexander Cu, Cupertino, CA (US); Fen-Ling Lin, San Jose, CA (US); Guogen Zhang, San Jose, CA (US); Qinghua Zou, Issaquah, WA (US)

Correspondence Address: SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/122,963

(22) Filed: May 19, 2008

Related U.S. Application Data
(63) Continuation of application No. 11/356,366, filed on Feb. 16, 2006.

(51) Int. Cl. G06F 17/30

(52) U.S. Cl. 707/100; 707/E17.044

(57) ABSTRACT

A method and system for evaluating a path query are disclosed. The path query corresponds to a query tree including a plurality of query nodes. At least one query node corresponds to at least one predicate and is at a level. The predicate(s) are evaluated for previous query node(s). The method and system include scanning data nodes of a document and determining if the data nodes match the query nodes. The method and system also include placing data related to the data node in match stacks corresponding to matched query nodes. The data for the query node(s) include attribute(s) corresponding to the predicate(s). The method and system further include propagating a matching of the at least one query node backward to a matching of the at least one previous query node.

### CROSS-REFERENCE TO RELATED APPLICATIONS

Under 35 USC §120, this application is a continuation application and claims the benefit of priority to co-pending U.S. patent application Ser. No. 11/356,366 filed entitled “Streaming XPath Algorithm for XPath Expression With Predicates”, filed on Feb. 16, 2006, which is related to U.S. patent application Ser. No. 10/990,834, filed on Nov. 16, 2004, entitled “Streaming XPath Algorithm for XPath Value Index Key Generation”, all of which is herein incorporated by reference.

### FIELD OF THE INVENTION

The present invention relates to XPath evaluation, and more particularly to the streaming evaluation of XPath expressions with predicates for data processing or network data routing.

### BACKGROUND OF THE INVENTION

XML databases and XML content-based routing are well known in the art. For XML databases, XPath is a language for accessing XML documents in the database. Efficient evaluation of XPath is of particular interest because evaluation of XPATH queries may greatly affect the performance and scalability of XML databases. Typically, XML documents are stored according to a tree data model, such as XQuery data model or Document Object Model (DOM). The nodes of the data tree are streamed and scanned. The XPath is then evaluated and a result which satisfies the XPath query is returned. For XML content-based routing, XML documents are parsed and XPath queries are evaluated. Data are sent based on the query results. High-performance of XPath evaluation is extremely important also.

One of ordinary skill in the art will recognize that conventional approaches of processing XPath queries on XML data streams, such as automata or transducer-based approaches, may suffer from various problems. Conventional approaches explicitly express all the possible matching paths for an input XML node in their state machines or working buffers. However, the number of matching paths can be very large in some situation. In particular, the number of combinations being tracked may grow near exponentially. Thus, this conventional approach may be very inefficient. Moreover, conventional approaches to XPath streaming also passively process every input node or event and do not or cannot skip uninterested XML sub-trees.

Moreover, predicates should be accounted for. Predicates add complexity to XPath evaluation because a predicate may refer to a value that may only be available at the end of the node with which it is associated. Thus, both candidate result nodes and data for the predicate evaluation may need to be buffered. Conventional methods do not buffer candidate result nodes efficiently enough.

Accordingly, there exists a need for an improved method for evaluating XPath with predicates. The method is preferably capable of processing XPath expressions more efficiently and requiring one scan of an XML document. The present invention addresses such a need.

### BRIEF SUMMARY OF THE INVENTION

The present invention provides a method and system for evaluating XPath queries with predicates. The method and system comprise providing a query tree including a plurality of query nodes. At least one of the query nodes corresponds to at least one predicate and has at least one level. The predicate is evaluated for at least one previous query node. The method and system comprise scanning a plurality of data nodes of a document and determining if the plurality of data nodes matches the plurality of query nodes. The method and system also comprise placing data related to the data node in match stacks corresponding to matched query nodes. The data for the at least one query node includes at least one attribute (or variable) corresponding to the at least one predicate. The method and system further comprise propagating a matching of the at least one query node backward to a matching of the at least one previous query node.

### BRIEF DESCRIPTION OF SEVERAL VIEWS OF THE DRAWINGS

FIG. 1 is a flowchart illustrating an embodiment of a method for evaluating queries in accordance with the present invention which accounts for predicates.

FIG. 2 is a flow chart depicting one embodiment of a method in accordance with the present invention for compiling a query.

FIG. 3 depicts templates for compiling queries in one embodiment of a method in accordance with the present invention.

FIG. 4 is a flow chart depicting one embodiment of a method in accordance with the present invention for evaluating a query, such as an XPath query.

FIG. 5 is a flow chart depicting one embodiment of a method in accordance with the present invention for evaluating predicates.

FIG. 6 depicts one embodiment of an exemplary path expression and a matching grid in accordance with the present invention.

FIG. 7 depicts another embodiment of an exemplary the path expression in accordance with the present invention.

FIG. 8A depicts an example of a query tree and an example document tree.

FIG. 8B depicts an example of a query tree with a matching condition when traversing the document tree to determine matches with query nodes.

FIG. 8C depicts an example of a query tree when propagating values backwards in the query tree to account for predicates.

FIGS. 9A-9B depicts embodiments of a tree and match stacks in accordance with the present invention.

FIG. 10 illustrates an example pseudo-code for scanning a document in accordance with the present invention.

FIG. 11 illustrates an example pseudo-code for matching a data node with query nodes in accordance with the present invention.

FIG. 12 illustrates an example pseudo-code for a procedure for clearing and processing ends of nodes in accordance with the present invention.

### DETAILED DESCRIPTION OF THE INVENTION

The present invention provides improved method for streaming evaluation of XPath with predicates. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Although the embodiments below are described in the context of XML documents and XPath, any hierarchical data and query language with similar characteristics to XPath can be used without departing from the spirit and scope of the present invention.

The present application is related co-pending U.S. patent application Ser. No. 10/990,834 entitled “Streaming XPath Algorithm for XPath Value Index Key Generation” Filed on Nov. 16, 2004 and assigned to the assignee of the present application. Applicant hereby incorporates by reference the above-identified co-pending patent application.

The present invention provides a method and system for evaluating queries, such as XPath queries. The method and system comprise providing a query tree including a plurality of query nodes. At least one of the query nodes corresponds to at least one predicate and is at a level. The predicate is evaluated for at least one previous query node. The method and system comprise scanning a plurality of data nodes of a document and determining if the plurality of data nodes matches the plurality of query nodes. The method and system also comprise placing data related to the data node in match stacks corresponding to matched query nodes. The data for the at least one query node includes at least one attribute corresponding to the at least one predicate. The method and system further comprise propagating at least one value for the at least one predicate backward from the at least one query node to the at least one previous query node.

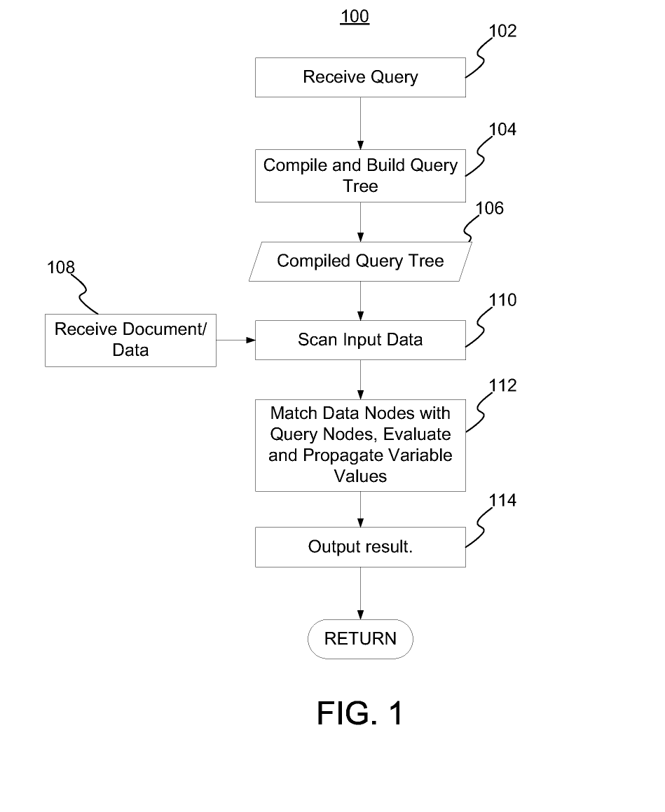

FIG. 1 is a flowchart illustrating an embodiment of a method 100 for evaluating queries, such as XPath queries, in accordance with the present invention which accounts for predicates. The method 100 is described in the context of XPath queries. However, one of ordinary skill in the art will readily recognize that the method 100 may be used with other queries.

A query that is preferably an XPath query is received for processing, via step 102. The query is then compiled and a query tree built, via step 104. The query tree is thus based upon the XPath query. The compiled query tree is provided, via step 106. Consequently, using steps 102, 104, and 106, an XPath query tree may be provided. The query tree is discussed below. XML data, for example in the form of a tree or stream, is received, via step 108. This XML data is scanned, via step 110. In step 110, the XML data is preferably scanned in order of the data nodes, with the node kind, the name, level (depth), node ID, and value being read. In a preferred embodiment, step 110 is performed using a single scan. In one embodiment, a portion of a data tree including data nodes and a query tree are available after step 110. The data nodes are matched against the query nodes, via step 112. Stated differently, it is determined whether the data nodes match the query nodes in step 112. Also in step 112, if data and query nodes do match, then the matching data nodes are placed in match stacks corresponding to the matched query nodes and predicates are accounted for by evaluating and propagating any variable values. Depending on whether the query node itself or other values associated with the query node are needed, the node and other values may be extracted and placed in the match stacks. Thus, the document is processed and matches found in step 112. Once the processing completes, the result may be outputted, via step 114.

To represent matches found in step 112, a logical stack or list of matching units is associated with each query node. Each matching unit contains a data node that matches with the query node, and the data nodes of the matching units in a stack have AD (i.e. ancestor-descendant) relationships among themselves.

The information contained in a matching unit includes:
Level: the depth of the matched XML data node.
Qid: the query node ID of the matched query node.
slink: the previous unit containing a node that matches with the same query node.
ulink: the unit on the previous step that is used in matching this node to the query node, if it is not the same as the previous unit in the same stack.
output: some attributes (variables) that will be propagated to other matching units following ulink and slink.
other variables: used to hold expression results or intermediate results during the processing. They vary depending on the query and query node.

The matching units are preferably stored in a match stack table. A stack top table preferably stores the addresses (or indexes) of the top matching units of logical stacks in the match stack table for each query node. If an XPath expression contains PC (i.e. parent-child) relationships only, then the stacks contain at most one entry each. Multiple entries in a stack occur for a query node that is at or below an AD step. For some matching units across the neighboring stacks, there are also relationships that are either PC or AD corresponding to the query steps. The matching units may thus form a matching grid. In turn, a matching grid can be represented by one combined stack or an array of stacks, one for each query node. Using an array may eliminate the cost of maintaining multiple stacks and improve locality during processing.

In a preferred embodiment, a data node matches a query node if the following three conditions hold: (1) if the query node is not the root step (the root step matches the document root), then there is a match for the query node in the previous step of the query; (2) the data node matches the query node of the current step (i.e., the node names match); and (3) the edges of the data and query nodes match. If the relationship between the query node of the current step and the query node of its previous step is a PC relationship, then condition (3) is satisfied if the level of the data node is the same as the level of the matching unit in the previous step plus one. If the relationship is an AD relationship, then condition (3) is satisfied if the level of the data node is greater than the level of the data node of the matching unit in the previous step.

When the query tree is large, it may be inefficient to test the three conditions for all the internal query nodes when a data node arrives. To improve the matching process for such a case, the active states for the queries may be maintained. A query node is “active” if it can potentially match the next data node in the XML stream. The set of active query nodes is called active states (AS). A query node is “direct” if the edge to its previous step is a solid line (PC relationship). Otherwise, it is “indirect” (AD relationship, or also called in-transitive). The active states are divided into two sets. The direct active states, once matched, may become inactive, while the indirect active states will continue to be active after their matchings. Note that initially only the root step is active.

Table 1 below depicts an embodiment of the rules of maintaining the direct active states. The next direct states are the union of direct query nodes of the current matched query nodes. When adding a data node, the set of matches (M) is first calculated. Then, the union of the direct nodes of the query nodes in M is obtained to get the resulting direct states. When removing matches from the stack, the most recent matches, i.e., the matches at the top of the stack with the largest level, can be obtained from the match stack table 504.

TABLE 1
Rules of maintaining direct active states

| Event | Initial States | Action | Next direct states |
|---|---|---|---|
| Add Node n | ds0: direct | Get a list M of matches | Union of direct |
| Remove matches | inds0: indirect | Let M be list of matches of | nodes of each query |
| | | largest level | node in M → ds1 |

Table 2 shows examples of rules for maintaining the indirect active states. An indirect query node is active only if the query node of the previous step has some matches. Thus, the stack of a query node is checked. If it is empty before adding a match, then its indirect nodes are activated. If it is empty after removing a match, then its indirect nodes are deactivated.

TABLE 2
Rules of maintaining indirect active states

| Event | Initial States | Action | Next indirect states |
|---|---|---|---|
| Add a match to stack | ds0: direct | Check if S is empty | If yes, add indirect nodes |
| S of qid | inds0: indirect | before adding match | of qid into inds0 → inds1 |
| Remove match from | | Check if S is empty | If yes, remove indirect |
| stack S of qid | | after removing | nodes of qid from inds0 → |
| | | match | inds1 |

Because the rules for maintaining direct and indirect active states are different, two hash tables (or other associative memory) are preferably used to keep track of the active states: a direct AS hash table for maintaining the direct active query nodes, and an indirect AS hash table for maintaining the indirect active query nodes.

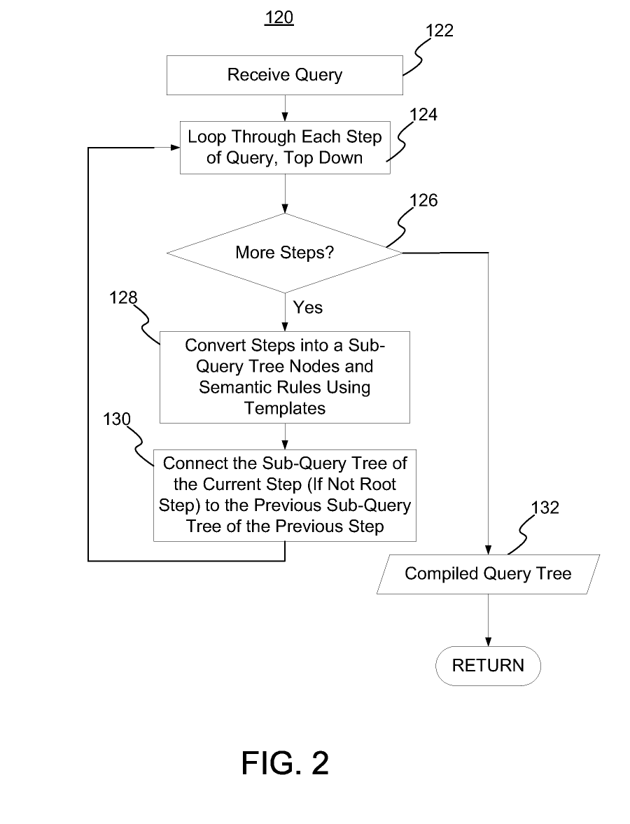

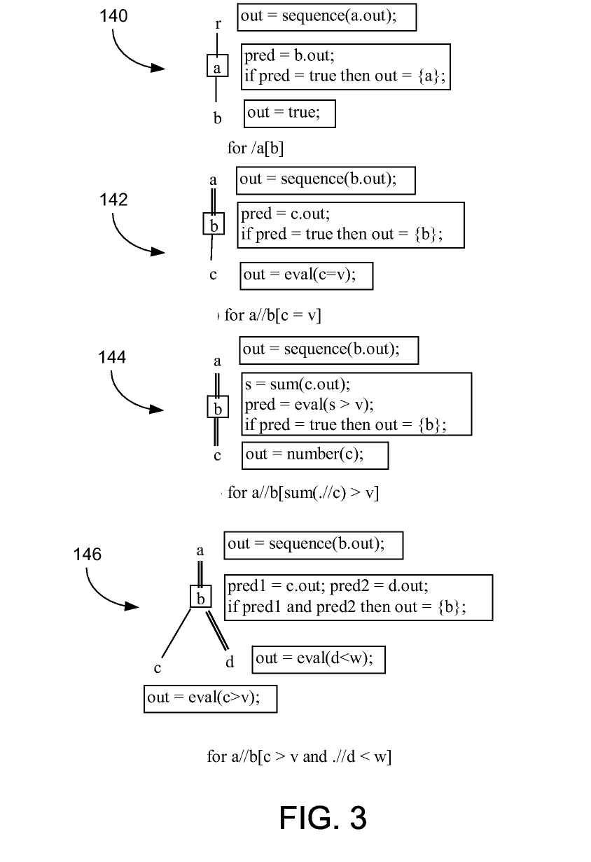

FIG. 2 is a flow chart depicting one embodiment of a method 120 in accordance with the present invention for compiling a query, such as an XPath query. Thus, the method 120 may be used in performing steps 102, 104, and 106 of the method 100. The query is received, via step 122. The query includes a number of steps. Each step of the query is looped through, from the beginning to the end, in order, via step 124. It is determined whether there is an additional step, via step 126. If there is an additional step in the query, then the additional step is converted into query tree nodes and semantic rules in accordance with templates for the query, via step 128. Examples of such templates 140, 142, 144, and 146 are shown in FIG. 3. If the current step is not the root (first) step, then the node corresponding to the current step is connected to the node for the previous step using a branch, or link, via step 130. It may be necessary to fill in attribute, also termed attribute variables herein, and rules into the query nodes of the previous steps based on the new step. If there are not additional steps, the query has been completely compiled. Consequently, the compiled query tree is output, via step 132.

The query tree provided using the method 120 includes query nodes and links. The link between two query nodes represents the relationship between the query nodes. For example parent-child (PC) or ancestor-descendant (AD) relationship. Thus, a query tree Q(V, E) is defined as follows. V is a set of query nodes. Each query node, q, corresponds to a step and may be labeled with a QName for the name test, and contains attribute definitions needed to evaluate the path expression, including the predicates associated with the step. E is a set of edges, or links, connecting two query nodes. Each edge represents a child or descendant relationship from one step to the previous step in correspondence to the axis of the step. Note that relative path expressions in predicates are merged into the query tree, and in predicates, relative path expressions are replaced with references to relevant attribute variables. Graphically single line is used to represent a child axis and double line a descendant axis. A dotted line is used to represent a segment of a query of less interest. The terms previous step and next step refer to a parent query node and child query node in a query tree, respectively.

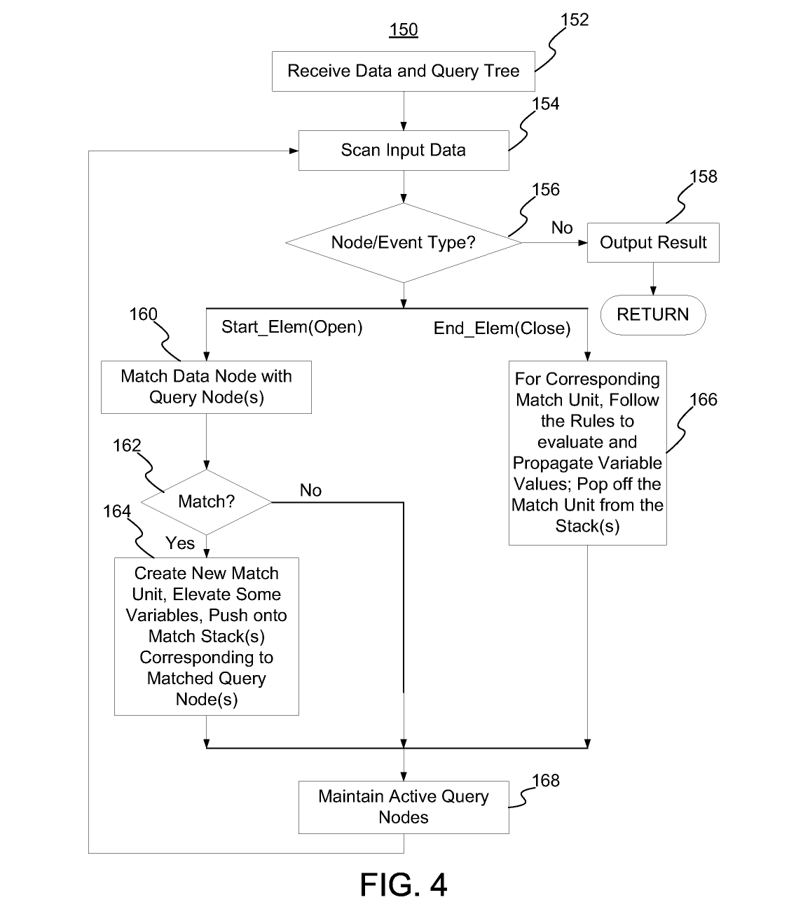

FIG. 4 depicts an embodiment of a method 150 for evaluating a query, such as an XPath query. The method 150 may thus be used in performing the steps 108, 110, 112 and 114 of the method 100, described above. The method 150 is preferably also used with XML data in the form of a data tree or stream and the XPath query. The data, for example in the form of a data tree, and the query tree are received, via step 152. The input data is scanned, via step 156. In a preferred embodiment, a single scan is used for the data. It is determined whether the data scanned corresponds to a node or event, via step 156. If it is the end of input data stream, then a result is output, via step 158. Otherwise, multiple steps may be performed depending on whether it is the start (OPEN) or the end (CLOSE) of an element node. If it is the start of a node, the data node is compared against the active query nodes in order to find matches, via step 160. It is determined for each data node and query node whether there is a match, via step 162. If not, then step 168, described below, is performed. If it is determined that the data node matches query nodes, then new matching units for the query nodes are created, attribute variables for the query node are evaluated, and the matched values for the data node are pushed onto the stacks, via step 164. Thus, when a data node matches a query node, one or more basic attributes about the matching may be extracted in step 164. Note that these attributes/attribute variables are attributes in an attribute grammar, well-known in the art, rather than being XML attributes. Consequently, the attributes are essentially variables having values. The basic functions resulting in scalar attribute values are listed in Table 3 below. They may be the result of applying a predicate or a function on the node. For example, an attribute can be used to represent the result of a primitive predicate w>300, which is a Boolean and associated with query node labeled “w” as push-down predicate. The value of this attribute will be propagated to a query node where the primitive predicate is used, possibly combined with other predicates there.

TABLE 3
Scalar Extract Functions for a Node

| Function | Type | Meaning |
|---|---|---|
| exist( ) | Boolean | True or False for existence test or evaluate a |
| eval(pred) | | predicate on a node |
| number( ) | number | Numeric String |
| string( ) | string | String value |
| node( ) | node | Node reference for use in sequences |

If a node matches a non-leaf query node, it may need to evaluate some aggregate attributes, such as the candidate result sequence (CRS), which contains nodes that matches the output query node but not yet fully filtered by the predicates, or the predicate truth value. Some of the aggregate functions are listed in Table 4 below. For example, five attributes will be involved in predicate a<b, which is equivalent to min(a)<max(b), and attribute value(a) and value(b) associated with query nodes labeled a and b are kept, and aggregate attributes min(a) and max(b) associated with their previous steps, and propagated to an ancestor step where min(a)<max(b) is calculated as another attribute and consumed.

TABLE 4
Some aggregate functions

| Function | Meaning |
|---|---|
| sequence( ) | A sequence of nodes or values |
| max( ) | The maximum value |
| min( ) | The minimum value |
| sum( ) | Summation of the values |
| count( ) | Count of occurrences or position of matchings |

To evaluate an aggregate attribute for a matching from the values of matchings beneath it, the following framework is followed: 1. Init function, which initializes the attribute(s); 2. Extract function, which applies to each matched child or descendant node; 3. Accumulate function, which evaluates new value(s) based on the current cumulative value(s) and new extracted value(s); and 4. Final function, which is the final evaluation of an attribute that may be based on a set of attributes at the matching node.

For example, if a step (node) has with predicate a[b=10], there will be an attribute p for the predicate, with the following functions: (1) init: to false; (2) extract: e:=if number(b)=10 then true else false; (3) accumulate: p=p or e; (4) final: none. If the predicate is [b=10 and c>“ABC”], then the final could be to evaluate the “and”. Notice that the above framework is essentially the same as evaluating an aggregate function in general, such as average, where multiple attributes are defined to get the final result.

In addition to performing the matching in steps 160, 162, and 164 at the start of a node, when finishing traversal of the descendants of a node and at the end of a node, the values for a data node may be used to account for predicates at a previous query node and for the query result, via step 166. In a preferred embodiment, performing step 166 includes following rules related to the predicate and propagating the value to the previous query node. In addition, the matching unit is preferably popped of the match stack in step 166.

After step 162, 164, or 166, the active query states (or nodes) are maintained, via step 168. Thus, the queries states which are active are tracked in step 168 updated with query nodes that become active or inactive. In one embodiment, it can be determined whether a query node is active by checking stack emptiness of a previous step. This may be achieved through the matching process of step 162 without using separate data structures. To reduce the number of query nodes to check, a name index to query nodes may be maintained. Consequently, only query nodes that match with the current node name may be checked. In another embodiment, active query nodes may be tracked by analyzing the query tree. The rules are described from paragraph [033] to [036]. In addition, early finish also impacts the state of a query node when a positional predicate turns to true. Early finish suppresses an active query node if the finish condition is true. In addition, the matching order preferably follows the breadth-first order of the query tree for the propagation scheme.

Thus, using the method 150, predicates can be accounted for. Moreover, the method 150 stores the attributes and utilizes stacks corresponding to the query nodes. This may eliminate the cost of maintaining multiple stacks and improve locality during processing. Moreover, the method 150 may only traverse query nodes in the tree for which matches are found. Consequently, the method 150 has improved efficiency.

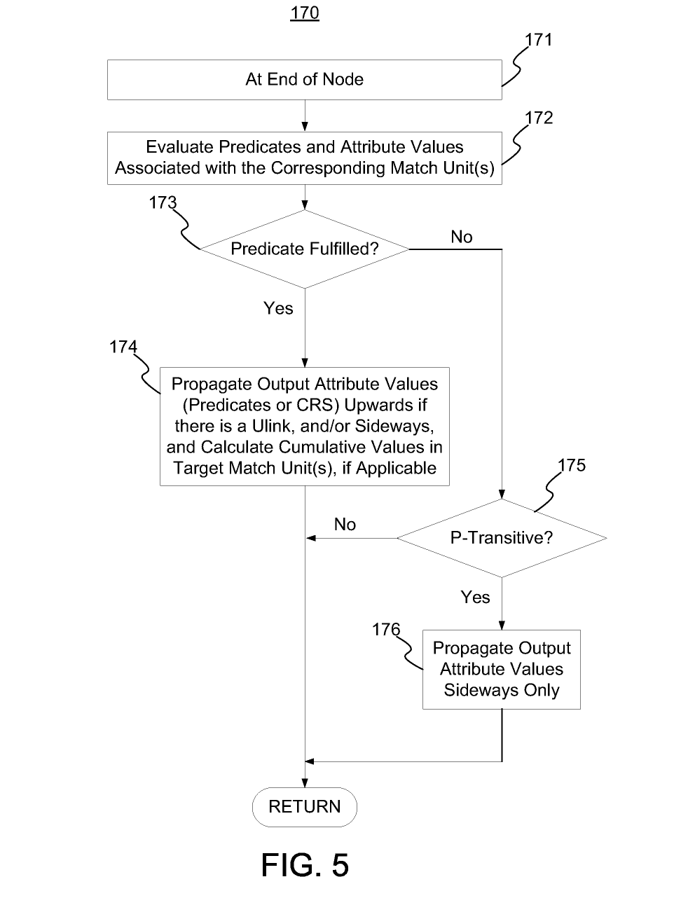

FIG. 5 is a flow chart depicting one embodiment of a method 170 in accordance with the present invention for evaluating predicates. The method 170 is preferably used to perform the step 112 and 166 of the methods 100 and 150, respectively. The end of a query node is reached, via step 171. The associated predicates and attribute values for the match are evaluated, via step 172. Thus, the values from the query node that may fulfill predicate(s) for previous query node(s) are evaluated in step 172. It is determined whether predicate(s) are fulfilled by the attributes of the node, via step 173. If so, the value from a query node for a predicate is propagated, via step 174. Stated differently, the values that are known to fulfill the predicate or are a possible match (a CRS) that may fulfill the predicate are propagated in step 174. Thus, the query tree may be traversed toward the root node when propagating upwards to a previous query node to which the predicate corresponds or sideways in step 174. Also in step 174 any cumulative values for the match (i.e. the corresponding matching unit) may be calculated. If it is determined that the predicate is not fulfilled in step 173, then it is determined whether the query node is transitive (otherwise termed p-transitive and described below), via step 175. In other words, it is determined in step 175 whether the relationship with the previous node adjacent to the current node allows for propagation both toward the root node and sideways. If so, then the attributes are only propagated sideways in step 176. Thus, using the method 170, predicates can be accounted for.

In one embodiment, in order to propagate a value in the method 100 or 170, attributes of the query nodes are considered. In particular, an attribute that indicates the relationship between query nodes, such as a sequence-valued attribute, may be utilized. The sequence-valued attribute is for the sequence of child nodes or descendant nodes. The rules to calculate such an attribute depend on the axis of a step, as shown in Table 5, where “U” means union of two sequences, which results in a new sequence with unique nodes from two sequences in document order.

TABLE 5
Propagation of basic sequence-valued attributes

| Path and matchings | Path, attributes, and propagations |
|---|---|
| 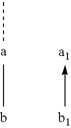 | Path: . . . a/bs: sequence of b children of aInit: s₁ := ε; // when a₁ is createdAt end of b₁: s₁ := s₁ ∪ {b₁}; // upward |
| 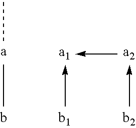 | Path: . . . a/bs: sequence of b children of aInit: sᵢ := ε; // when aᵢ is createdAt end of bᵢ: sᵢ := sᵢ ∪ {bᵢ}; // upward// no sideways propagation for s |
| 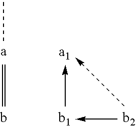 | Path: . . . a//bs: sequence of b descendants of at: sequence of b descendant-or-self of bInit: s₁ := ε; // when a₁ is created tᵢ := {bᵢ}; // when bᵢ is createdAt end of b₂: t₁ := t₁ ∪ t₂; // sidewaysAt end of b₁: s₁ := s₁ ∪ t₁; // upward |
| 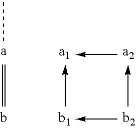 | Path: . . . a//bs: sequence of b descendants of at: sequence of b descendant-or-self of bInit: sᵢ := ε; // when aᵢ is created tᵢ := {bᵢ}; // when bᵢ is createdAt end of bᵢ: sᵢ := sᵢ ∪ tᵢ; // upwardAt end of b₂: t₁ := t₁ ∪ t₂; // sideways |

Thus, as can be seen in Table 5, an attribute for a sequence of children is not transitive, while an attribute for a sequence of descendant-or-self is transitive, called p-transitive. When an attribute is p-transitive, its value may be propagated sideways at the end as well as upward if there is an upward link. In the last case of Table 5, duplicate propagation may be avoided if: for b: propagate upward if there is an upward link or else propagate sideways, and for a: propagate sideways and accumulate for b descendants of a. As a result, there may be no duplicates and document order may be guaranteed for b descendants of a using simple concatenation.

If there is a predicate associated with a particular query node, then duplicate propagation may be avoided using another mechanism. If there is a predicate p for query node b, for all the cases in Table 5 (paths: . . . a/b[p], . . . a//b[p]), upward propagation is allowed only if the predicate p is true. If the predicate p is false, the matching unit is dropped, but it will allow sideways propagation to pass through. When a predicate p is associated with a in . . . a[p]//b, the sideways propagation of sequence of b descendants of a between a matching units is not affected by predicate p.

In addition, it may be desirable to propagate a possible match, or CRS, for a path expression beyond two steps, or two successive query nodes in the query tree. Whether or not a CRS attribute is transitive depends on a step. For a pair of steps p and q, if PC(p, q), m(p, d₁), m(q, d₂), and PC(d₁, d₂) then s(d₂), CRS at d₂, can be propagated upward to d₁, but not to an ancestor of d₁, such as do, where m(p, d₀) and AD(d₀, d₁), because PC(d₀, d₂) is not true. Thus, a CRS attribute is not p-transitive on a previous step of a child axis. Similarly, a CRS attribute is p-transitive on a previous step of a descendant axis. This property is independent of whether the result query node has child axis or descendant axis. For example, for a query/a[u]/b[v]/c[w]//d, a sequence of d descendants can be propagated sideways at step c, but as a CRS, it cannot be propagated sideways at step b or a. If we have query //a[u]//b[v]/c[w]//d/e, a CRS can be propagated at step c, a, or root, but not b.

In general, when there is no predicate, the following simple propagation rules will guarantee no duplicates in a CRS:
propagate upward if there is the upward link for a matching unit and the step is p-transitive, or the step is not p-transitive;
otherwise, propagate sideways (i.e. if the step is p-transitive and there is no upward link).

Simple concatenation for accumulation can guarantee uniqueness and document order of a CRS. However, when predicates are present, the simple propagation rules become problematic. The following propagation rules apply when there are predicates:
For a p-transitive step, propagate upward if the predicate is true and there is an upward link, or propagate sideways if the predicate is false or there is no upward link. If there is no predicate at a step, it defaults to true;
For a non p-transitive step, propagate upward if the predicate is true, or propagate to the stack top matching in the highest p-transitive step below the consecutive non p-transitive steps if the predicate is false. A CRS is dropped if there is no such matching unit.

The rationale is that we keep propagating a CRS along the matching path as long as the predicate is true. However, if a false predicate is encountered, a different matching path may be used. Some examples will make this clear.

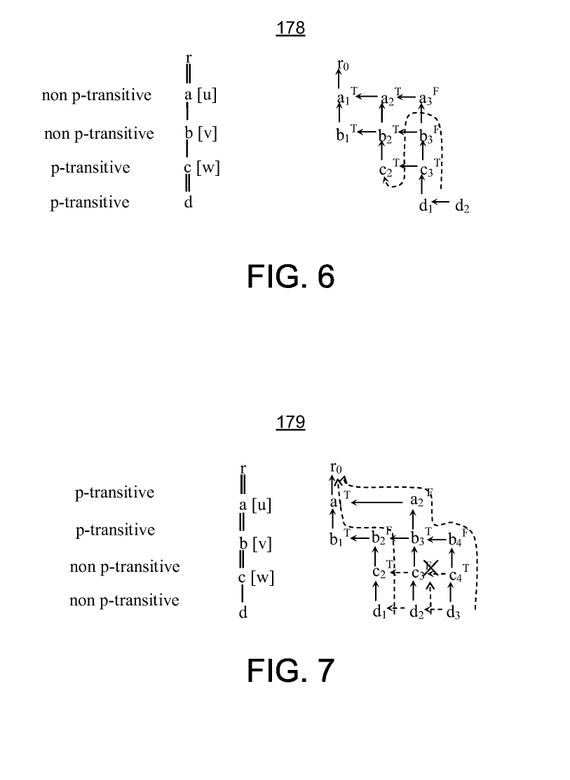

FIG. 6 depicts one embodiment 178 of an exemplary path expression and a matching grid in accordance with the present invention. The path expression is //a[u]/b[v]/c[w]//d, and a matching grid example is shown with the predicate truth values marked as superscript on each matching unit. The CRS {d₁, d₂} is propagated to c₃ first. As the predicate is true, it will be propagated upward to b₃. Because the predicate for b₃ is false and step b is not p-transitive, the CRS will feed to c₂, as the dotted line shows. The CRS {d₁, d₂} will eventually reach the root and become part of the result. The existence of c₂ with a predicate being true is critical.

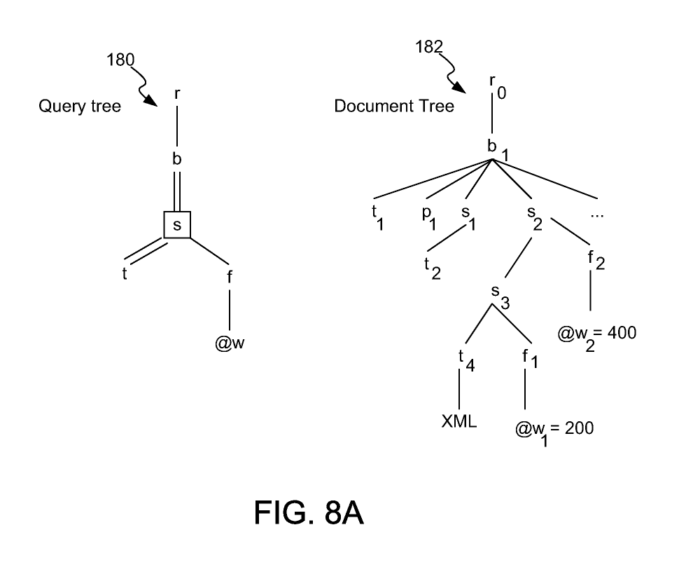

FIG. 7 depicts another embodiment 179 of an exemplary the path expression in accordance with the present invention. The path expression is //a[u]//b[v]//c[w]/d. The matching units for d can only be propagated upward to matching units of b, and d₂ does not survive the predicate on c₃. Although the false value of predicates at b₂, b₄ and a₂ is not welcoming, d₁ and d₃ survive through the sideways propagation and reach the root as the result.

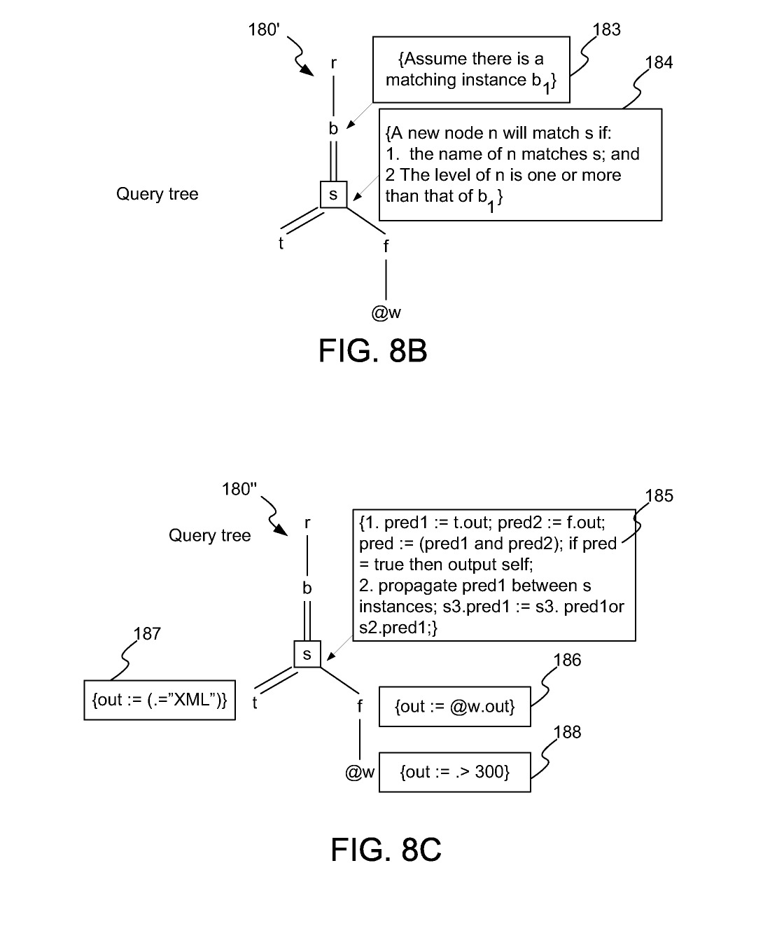

The methods 100, 150, and 170 and description above may be further understood using an exemplary expression, such as the expression /book//section[.//title =“XML” and figure/@width>300]. FIG. 8A depicts an example of a query tree 180 formed in accordance with the present invention and a data tree 182 that represents a document that which will be tested against the query tree 180 for matches. The query tree 180, including the trees 180′ and 180″, discussed below, may be formed in step 104 or 132 of the methods 100 or 120, respectively. The data tree 182 corresponds to the document being scanned in step 110 or 154 of the methods 100 and 150, respectively. In the tree 180, the node b is for book, s is for section, f is for figure and t is for title. Thus, the nodes t, f, and @w correspond to predicates. The document includes root node r₀, book node b₁, nodes p₁, s₁, s₂, t₁, t₂, t₃, t₄, f₁, f₂, as well as other nodes (not explicitly shown).

FIG. 8B depicts an example of the query tree 180′ when traversing the data tree to determine matches with query nodes. Thus, the query tree 180′ is effectively the query tree 180 while in use, for example in steps 160, 162, 164, and 166. Thus, matching conditions 183 and 184 are indicated at nodes b and s these nodes will require that the matching conditions corresponding to nodes b and s are fulfilled. Thus, using the tree 180′, it can be determined in step 162 that r₀ matches r and that b should have a match b₁. Also using the tree 180′, it can be determined that the data nodes t₁ and p₁ cannot match s. Consequently, the branches of the document tree 182 not corresponding to data nodes t₁ and p₁ are skipped for subsequent levels of the tree. The data nodes s₁, s₂, and s₃ are potential matches for s. However, the predicates about t, f, and @w must be fulfilled. Consequently, the nodes corresponding to t, f, and @w are tested for matches. Once the matches have propagated down to t, f, and @w, it can be determined whether the predicates are fulfilled.

FIG. 8C depicts an example of the query tree 180″ when propagating backwards in the query tree to account for predicates. Thus, the query tree 180″ is effectively the query tree 180 while in use, for example in step 166 or the method 170. The data, or values, corresponding to the predicate [.//title=“XML” and figure/@width>300] are handled using predicates 185, 186, 187, 188. In operation, the variable out in predicate 188 corresponds to the value of @w and which is true for w₂ in the data tree 182. This value is propagated back to the node f. At the node f,f₁ is not a match, while f₂ may be a match. The value for f₂ is desired to be propagated back to the node s. Consequently, using the predicate 186, this value is propagated back to the node s. Similarly, the value out for t=XML is propagated back to the node s using the predicate 187. For the data nodes t₂ and t₃, the predicate is not true because no predicates f and @w can be obtained on the branches of the data tree 182. Thus, these branches of the tree 182 are skipped. However, for the data node t₄, a match is obtained. Consequently, using the predicate 187, the value of t, may be propagated back. Thus, the value t₄ is propagated back to the node s. Once the values for @w, f, and t are propagated back to the node s, it can be determined, using predicate 185, whether the predicate [.//t=“XML” and f/@w>300] for node s is fulfilled. Because it is so, the node s₂ is added to the match stack for the s node of the query tree 180/180′/180″.

Consequently, the predicate may be accounted for using the method 170 and query trees 180, 180, and 180″. At the same time, documents can be efficiently scanned and matched to queries.

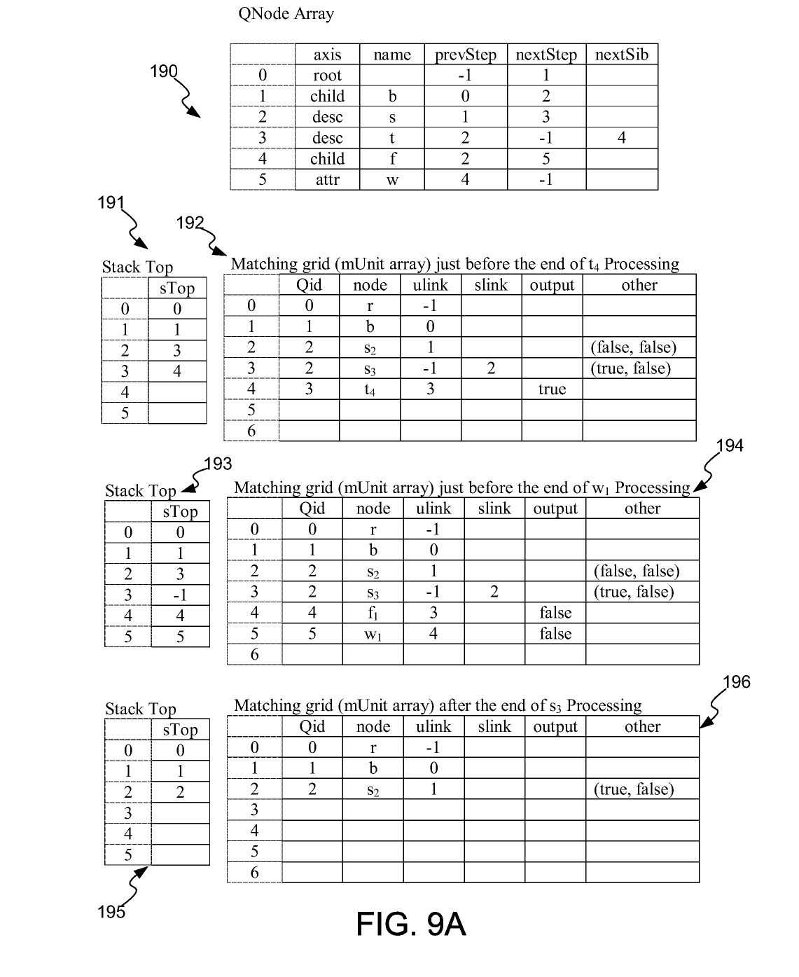

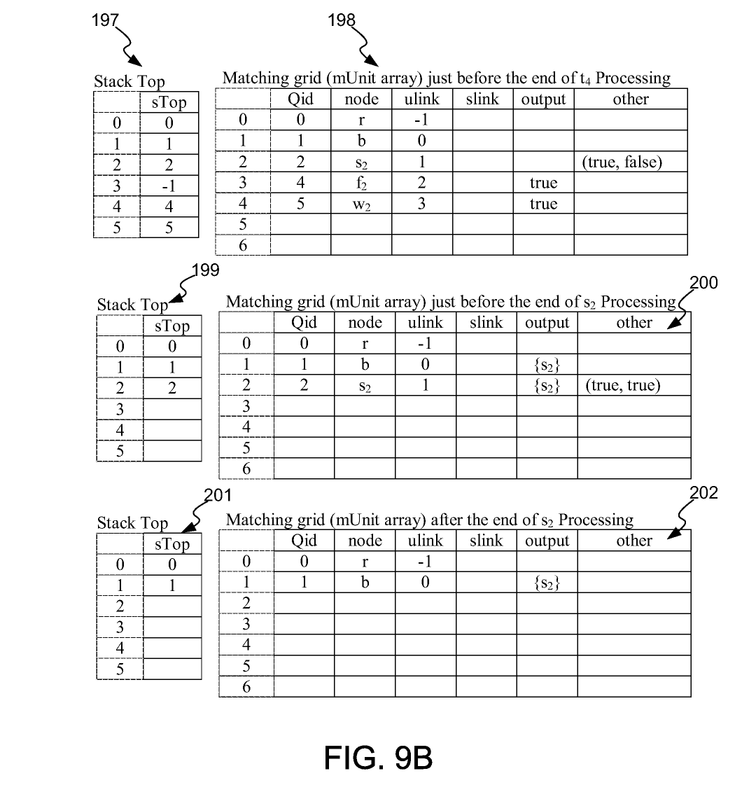

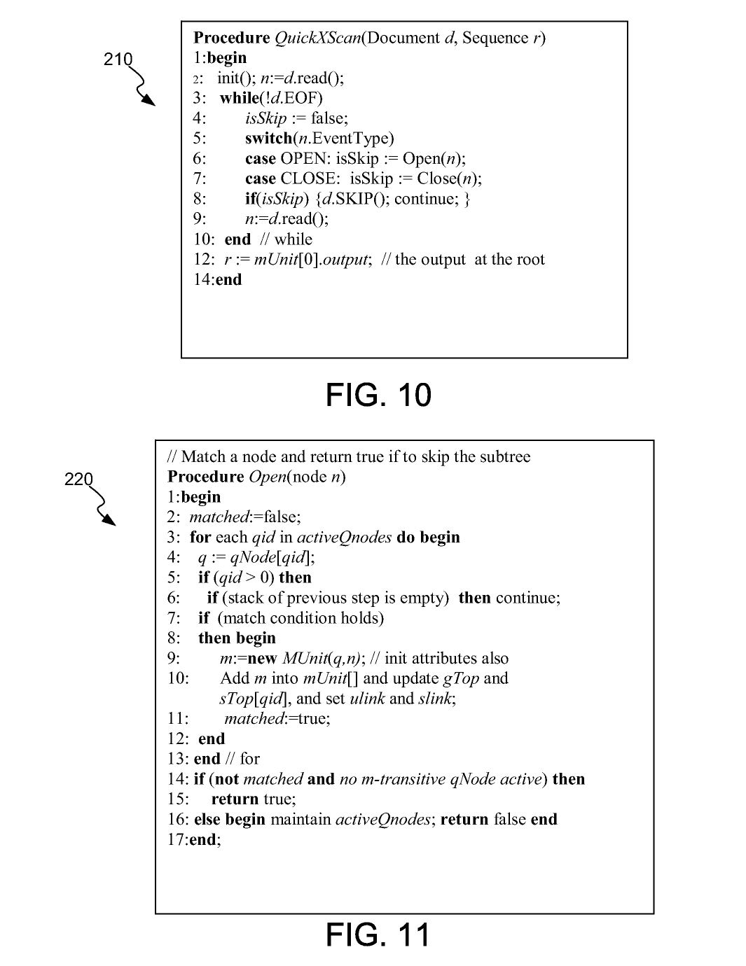

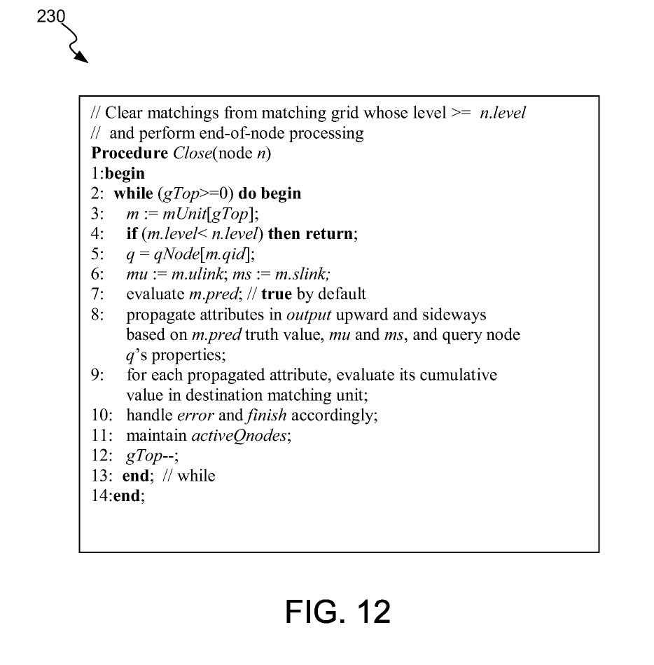

FIGS. 9A-9B depicts embodiments of the tree 180 and match stacks 190, 191, 192, 193, 194, 195, 196, 197, 198, 199, 200, 201, and 202 at various points of time during the evaluation in accordance with the present invention. FIGS. 10-12 illustrate embodiments in which, the methods 160 and 170 may be performed as part of subroutines called by another procedure. FIG. 10 illustrates an example pseudo-code 210 for a procedure for scanning a document in accordance with the present invention. FIG. 11 illustrates an example pseudo-code 220 for matching the key generation in accordance with the present invention. FIG. 12 illustrates an example pseudo-code 230 for a procedure for clearing and processing ends of nodes in accordance with the present invention. The pseudo-code 210 thus performs the scanning in methods 100 and 150. The pseudo-code 220 is an example of a match subroutine that may be used in the steps 112 and 162. The pseudo-code 220 also tests conditions for skip a subtree. The pseudo-code 230 also clears nodes for which traversal has passed. Thus, the method 150 may skip branches of the data tree, such as some branches in the data tree 182, for which matches are not found.

A method and system for evaluating hierarchical path queries that accounts for predicates are disclosed. The present invention has been described in accordance with the embodiments shown, and one of ordinary skill in the art will readily recognize that there could be variations to the embodiments, and any variations would be within the spirit and scope of the present invention, such as in a computer network having linked electronic devices and applications generally of any combination of programming and/or hardware capable of distributing an application over the network, where such often includes a computer with a processor, storage medium, bus, and program code operable thereon. The invention can take the form of a computer program product accessible from a computer-usable or computer-readable medium providing program code for use by or in connection with a computer or any instruction execution system. For instance, in one implementation, the present invention is directed to a computer program product including a computer-readable medium having instructions stored thereon for processing data information, such that the instructions, when carried out by a processing device, enable the processing device to perform the steps of streaming evaluation of a XPath path query, the path query corresponding to a query tree including a plurality of query nodes, at least one query node of the plurality of query nodes corresponding to at least one predicate and having a level, the at least one predicate being for at least one previous query node, the program including instructions for: singly scanning a plurality of data nodes of an XML document in order of the data nodes with node kind, name, level, node ID and value being read to provide a data tree; determining if the plurality of data nodes match the plurality of query nodes. For the purposes of this description, a computer-usable or computer readable medium can be any medium that can contain, store, or maintain programs and data for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as a floppy diskette or hard drive, a random access memory (RAM), a read-only memory (ROM), an erasable programmable read-only memory, or a portable compact disc.

We claim:

1. A computer-readable medium containing a program providing for streaming evaluation of a path query, the path query corresponding to a query tree including a plurality of query nodes, at least one query node of the plurality of query nodes corresponding to at least one predicate and having a level, the at least one predicate being for at least one previous query node, the program including instructions for: singly scanning a plurality of data nodes of an XML document in order of the data nodes with node kind, name, level, node ID and value being read to provide a data tree; determining if the plurality of data nodes match the plurality of query nodes; where if matching occurs, placing matching data nodes in match stacks corresponding to matched query nodes, the data for the at least one query node including at least one attribute corresponding to the at least one predicate; and propagating a matching of the at least one query node backward to a matching of the at least one previous query node, wherein the path query is an XPath query.

2. The computer-readable medium of claim 1 wherein the plurality of query nodes includes a root query node, the plurality of query nodes are related by branches of the query tree, and wherein the determining instructions further includes instructions for: traversing the data tree from the root query node along a first portion of the plurality of branches.

3. The computer-readable medium of claim 2 wherein the propagating instructions further includes instructions for: traversing the tree along a second portion of the plurality branches toward the root data node or sideways.

4. The computer-readable medium of claim 1 wherein the program further includes instructions for: skipping descendants of a data node if a data node does not match a corresponding query node.

5. The computer-readable medium of claim 2 wherein the query tree including a plurality of leaves corresponding to a portion of the plurality of query nodes, the program further including instructions for: providing an output corresponding to at least one leaf of the plurality of leaves if the at least one leaf corresponds to at least one matched query node.

6. The computer-readable medium of claim 1 wherein the placing instructions further includes instructions for: storing at least one variable corresponding to the at least one predicate for the at least one previous query node; and providing the at least one value for the at least one variable when the at least one node is traversed.

7. The computer-readable medium of claim 6 wherein the propagating instructions further includes instructions for: dropping the at least one previous node for each of the at least one value indicating that the at least one predicate is not fulfilled.

8. The computer-readable medium of claim 1 wherein the plurality of query nodes have child or descendant relationships.

9. The computer-readable medium of claim 1, wherein the determining if the plurality of data nodes match the plurality of query nodes further comprises evaluating each of three conditions following as true: (1) where a query node is not a root step, then there is a match for the query node in a previous step of the query; (2) where a data node matches a query node of a current step; and (3) where edges of one or more data nodes and query nodes match; provided that if (a) a relationship between the query node of the current step and the query node of the previous step is a parent-child relationship, then condition (3) is satisfied if where the level of the data node is the same as the level of a matching unit in the previous step plus one, or (b) if the relationship is an ancestor-descendant relationship, then condition (3) is satisfied if the level of the data node is greater than the level of the data node of the matching unit in the previous step.

10. The computer-readable medium of claim 9, wherein the matching unit and addresses of top matching units of logical stacks are stored in a match stack table.

11. A computer-implemented system for evaluating a query, the system comprising:
a data storage device and means for storing; a query tree including a plurality of query nodes, at least one query node of the plurality of query nodes corresponding at least one predicate and having a level, the at least one predicate being evaluated for at least one previous query node, the query tree for determining if a plurality of data nodes of a data tree corresponding to a scanned document matches the plurality of query nodes, and a matching of the at least one query node to be propagated backward to a matching of the at least one previous query node; a plurality of matched stacks for storing data related to the data node in match stacks corresponding to matched query nodes, the data for the at least one query node including at least one attribute corresponding to the at least one predicate and a processor and means for matching the at least one query node.

12. The system of claim 11 wherein the plurality of query nodes have child or descendant relationships.

13. The system of claim 11, wherein the determining if the plurality of data nodes match the plurality of query nodes further comprises evaluating each of three conditions following as true: (1) where a query node is not a root step, then there is a match for the query node in a previous step of the query; (2) where a data node matches a query node of a current step; and (3) where edges of one or more data nodes and query nodes match; provided that if (a) a relationship between the query node of the current step and the query node of the previous step is a parent-child relationship, then condition (3) is satisfied if where the level of the data node is the same as the level of a matching unit in the previous step plus one, or (b) if the relationship is an ancestor-descendant relationship, then condition (3) is satisfied if the level of the data node is greater than the level of the data node of the matching unit in the previous step.

14. The system of claim 13, wherein the matching unit and addresses of top matching units of logical stacks are stored in a match stack table.

15. A computer program product including a computer-readable medium having instructions stored thereon for processing data information, such that the instructions, when carried out by a processing device, enable the processing device to perform the steps of streaming evaluation of a XPath path query, the path query corresponding to a query tree including a plurality of query nodes, at least one query node of the plurality of query nodes corresponding to at least one predicate and having a level, the at least one predicate being for at least one previous query node, the program including instructions for: singly scanning a plurality of data nodes of an XML document in order of the data nodes with node kind, name, level, node ID and value being read to provide a data tree; determining if the plurality of data nodes match the plurality of query nodes; where if matching occurs, placing matching data nodes in match stacks corresponding to matched query nodes, the data for the at least one query node including at least one attribute corresponding to the at least one predicate; and propagating a matching of the at least one query node backward to a matching of the at least one previous query node, wherein the plurality of query nodes includes a root query node, the plurality of query nodes are related by branches of the query tree; and wherein the determining instructions further includes instructions for: traversing the data tree from the root query node along a first portion of the plurality of branches; and evaluating for truthfulness each of three conditions following: (1) where a query node is not a root step, then there is a match for the query node in a previous step of the query; (2) where a data node matches a query node of a current step; and (3) where edges of one or more data nodes and query nodes match, such that if all three conditions are true, then data nodes match query nodes; provided that if (a) a relationship between the query node of the current step and the query node of the previous step is a parent-child relationship, then condition (3) is satisfied if where the level of the data node is the same as the level of a matching unit in the previous step plus one, or (b) if the relationship is an ancestor-descendant relationship, then condition (3) is satisfied if the level of the data node is greater than the level of the data node of the matching unit in the previous step.

16. The product of claim 15, wherein the matching unit and addresses of top matching units of logical stacks are stored in a match stack table.

17. The product of claim 15 wherein the propagating instructions further includes instructions for: dropping the at least one previous node for each of the at least one value indicating that the at least one predicate is not fulfilled.

18. The product of claim 15 wherein the plurality of query nodes have child or descendant relationships.
